(19) United States
(12) Patent Application Publication
(10) Pub. No.: US 2009/0289406 A1
(43) Pub. Date: Nov. 26, 2009

(54) Method of, and apparatus for, processing a moving, printed material web

(75) Inventors: Jakob Gerhard, Brittnau (CH); Martin Gfeller, Oftringen (CH)

Correspondence Address: OLIFF & BERRIDGE, PLC, P.O. BOX 320850, ALEXANDRIA, VA, 22320-4850, US

(73) Assignee: HUNKELER AG, WIKON (CH)

(21) Appl. No.: 12/453,661

(22) Filed: May 18, 2009

(30) Foreign Application Priority Data
May 20, 2008 (EP) 08 009 232.3

(51) Int. Cl. B41F 13/58

(52) U.S. Cl. 270/5.02

(57) ABSTRACT

A method and apparatus of moving printed material web includes two processing arrangements arranged one above the other that are optional in operation. A material web is processed either in the upper, first processing arrangement or in the lower, second processing arrangement. In the processing section belonging to the first processing arrangement, the material web is folded about a line parallel to its advancement direction. In the processing section belonging to the second processing arrangement, the material web is separated, along a line parallel to its advancement direction, into two material-web strands, which are then positioned one above the other. The two processing sections having in common a pair of braking rollers and a pair of drawing rollers and also a longitudinal-cutter.

### BACKGROUND

The present invention relates to methods of, and apparatus for, processing a printed material web moving in an advancement direction. The material web is preferably printed by a digital printer.

It is known for endless material webs printed in a digital printer to be processed into end products in a processing line following the digital printer. It is desirable for end products of various types to be produced using the same processing line.

### SUMMARY

One object of the present invention, is to provide method and apparatus which make it possible for printed material webs to undergo different kinds of processing in a time-saving and space-saving manner.

Two processing sections are used on an optional basis and allow a printed material web to undergo different kinds of processing, and make it possible for products of different types to be produced in one and the same processing line. Arranging the processing sections one above the other shortens the processing line, which gives rise to a space-saving construction. Using a folding mechanism of roof-like design for the longitudinal folding of the material web also contributes to such a space-saving construction. Changeover from one processing mode to the other processing mode, i.e. changeover from processing of the material web in the one processing section to processing in the other processing section, can be done easily in that, when the one processing section is not in use, it is moved, preferably by lateral displacement, into a non-operational position outside the movement path of the material web.

### BRIEF DESCRIPTION OF THE DRAWINGS

FIGS. 1 and 2 are a side view and a plan view, respectively, of the apparatus according to an embodiment of the invention during longitudinal folding of the material web,

FIG. 3 is a schematic of the folded material web as seen in the direction of the arrow A in FIG. 2,

FIGS. 4 and 5 show a side view and a plan view, respectively, of the apparatus according to an embodiment of the invention during longitudinal cutting of the material web and positioning of the material-web strands one above the other,

FIG. 6 shows two material-web strands located one above the other, as seen in the direction of the arrow B in FIG. 5,

FIG. 7 shows a front view of the two processing arrangements arranged one above the other, with the upper processing arrangement in its operating position,

FIG. 8 shows a front view of the two processing arrangements arranged one above the other, with the upper processing arrangement in a non-operational position,

FIGS. 9 and 10 show a side view and a plan view, respectively, of the apparatus according to an embodiment of the invention for the longitudinal folding of the material web,

FIG. 11 shows the folded product as seen in the direction of the arrow C in FIG. 10, and

FIG. 12 shows a variant of the folded product in the direction of the arrow C in FIG. 10.

### DETAILED DESCRIPTION OF EMBODIMENTS

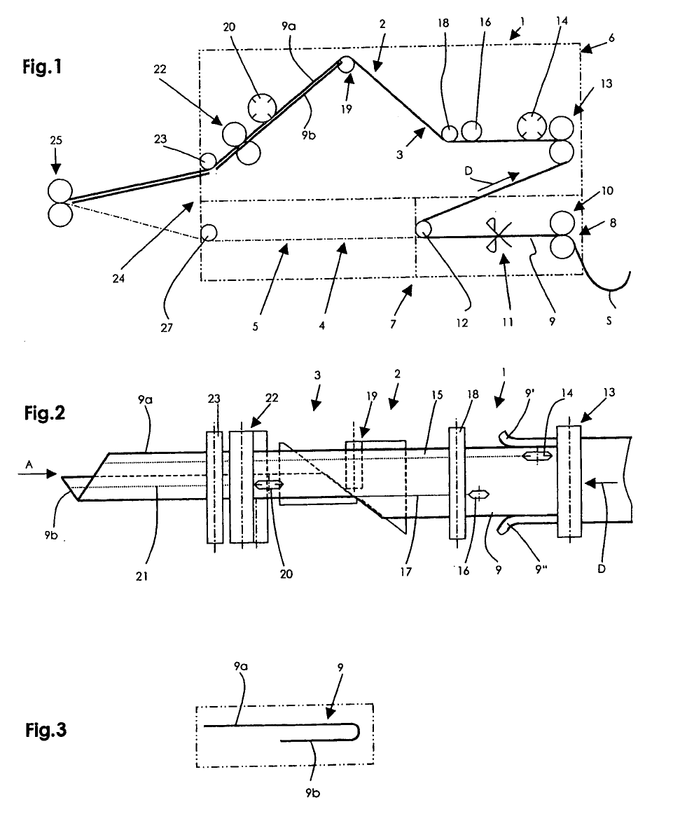

The construction of the processing apparatus 1 according to the invention will be described in the first instance with reference to FIGS. 1, 2 and 4, 5.

This processing apparatus 1 has a first processing arrangement 2 with a first processing section 3 and a second processing arrangement 4 with a second processing section 5. The processing arrangement 2 belongs to a first processing unit 6, while the second processing arrangement 4 belongs to a second processing unit 7. The two processing units 6 and 7 are arranged one above the other and have a common entry 8 for the material web 9 which is to be processed.

The material web 9, which runs into the processing apparatus 1 through the entry 8, runs through a pair of braking rollers 10, which has a merely schematically indicated longitudinal-cutting means 11 arranged downstream of it, as seen in the running direction D of the material web 9. As FIG. 5 shows, this longitudinal-cutting means 11 has a web-cutting unit 11a which serves for the longitudinal cutting of the material web 9 along a line parallel to the advancement direction D. The longitudinal-cutting means 11 also includes border-cutting units 11b and 11c which serve, if required, to cut away the border portions 9′ and 9″ of the material web 9. A deflecting roller 12 is arranged downstream of the longitudinal-cutting means 11. The pair of braking rollers 10, the longitudinal-cutting means 11 and the deflecting roller 12 are accommodated in the lower processing unit 7 and belong both to the first processing section 3 and the second processing section 5.

The first processing section 3 also has a pair of transporting rollers 13 and a perforating unit 14, which are both accommodated in the upper processing unit 6. The perforating unit 14 serves to produce longitudinal perforations 15 (tear-off perforations). It is also possible, however, for the perforating unit 14 to be set such that the line of perforations 15 is located along the envisaged folding line. The perforating unit 14 has arranged downstream of it a scoring unit 16 which provides the material web 9 with scoring 17 running along the envisaged folding line. It is also possible, however, to dispense with the scoring unit 16. In this case, folding takes place without scoring 17. As FIG. 2 shows, this scoring 17 (and thus the folding line) may be offset laterally in relation to the center line of the material web 9. Provided downstream of the scoring unit 16, as seen in the advancement direction D of the material web 9, is a web-guiding roller 18, which is followed by a roof-like folding mechanism 19, which is indicated in FIG. 1. This folding mechanism 19 serves for folding the material web 9 along a folding line in a manner known per se. The folded material web runs past a second perforating unit 20, which produces longitudinal perforations 21 (tear-off perforations) which pass through the two material-web strands 9a, 9b located one above the other. It is also possible, however, for this second perforating unit 20 to be dispensed with. Arranged downstream of the perforating unit 20 is a pair of transporting rollers 22, which is followed by a compensating roller 23 which is arranged in the region of the exit 24 from the processing apparatus 1. A pair of drawing rollers 25 is also provided in this exit region 24. In the case of the exemplary embodiment shown in the figures, this pair of drawing rollers 25 is part of a downstream cross-cutting means, which is not shown in any more detail. It is also possible, however, for this pair of drawing rollers 25 to be configured as part of the processing apparatus 1.

The above described structural elements 13, 14, 16, 18, 20, 22 and 23 belonging to the first processing section 3 are accommodated in the upper processing unit 6.

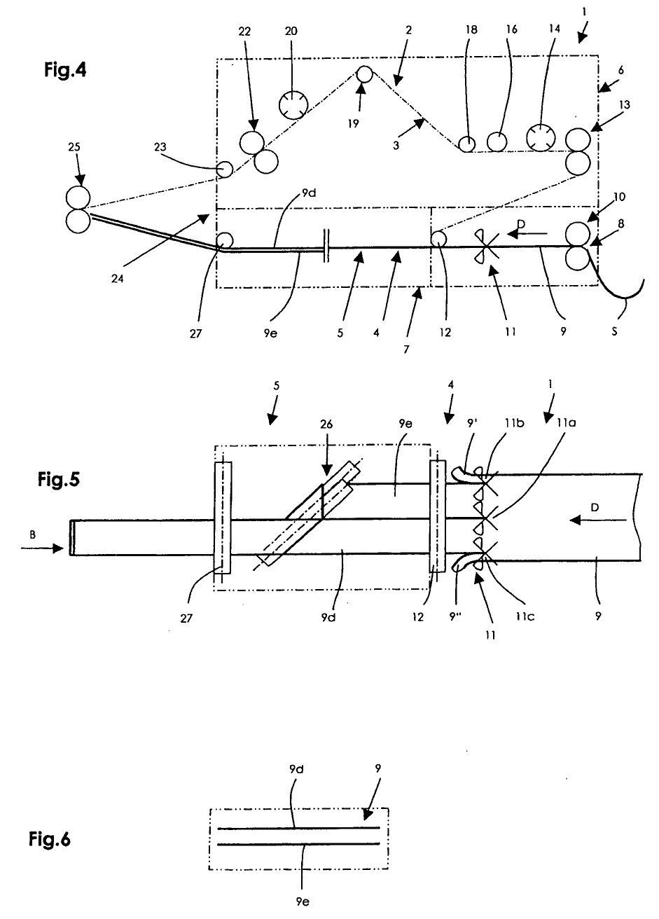

As can be gathered, in particular, from FIGS. 4 and 5, the lower, second processing arrangement 4, in addition to the pair of braking rollers 10, the longitudinal-cutting means 11 and the deflecting roller 12, which in the second processing arrangement 4 serves only as a web-guiding roller, also includes angle bars 26, via which the one material-web strand 9e is guided, and the web-guiding roller 27, which is arranged in the region of the exit 24.

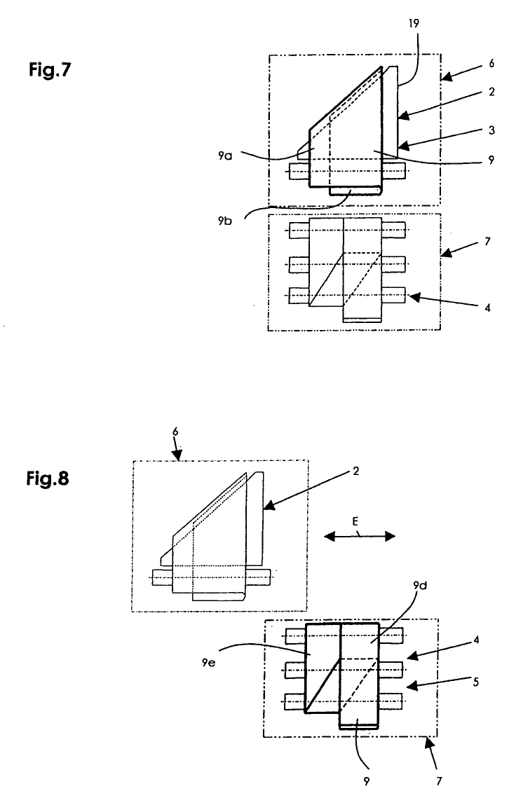

The two processing arrangements 2 and 4 arranged one above the other are used alternately—as is yet to be described. If the material web 9 is to be processed in the upper processing section 2, that is to say folded, then the upper processing unit 6 is located in its operating position, which is shown in FIG. 7 and in which it is located above the lower processing unit 7 and thus in the movement path of the material web 9.

If, in contrast, the material web 9 is to be processed in the lower, second processing section 5, then the upper processing unit 6 is moved into its non-operational position, which is illustrated in FIG. 8. This is done by the upper processing unit 6 being displaced laterally in a direction E, which runs at right angles to the advancement direction D of the material web 9 as is illustrated in FIG. 8. In this non-operational position, the upper processing unit 6 is thus located to the side of the movement path of the material web 9.

A description will now be given hereinbelow of how the material web 9 is processed either in the upper, first processing section 3 or in the lower, second processing section 5.

FIGS. 1-3, then, will be used to explain the processing of the material web 9 in the upper processing section 3.

As FIG. 1 shows, the material web 9 is fed in a loop S to the entry 8 of the processing apparatus 1. The tensile stressing in the material web 9 running through the processing apparatus 1 is produced by the pair of braking rollers 10 and the pair of drawing rollers 25. As the material web 9 runs past the longitudinal-cutting means 11, the border portions 9′ and 9″ (FIG. 2) are severed. The web-cutting unit 11a is not activated here. The material web 9 is then guided upwards, via the deflecting roller 12, into the upper processing unit 6. The material web 9 then runs through the pair of transporting rollers 13 and is subsequently provided with longitudinal perforations 15 by means of the perforating unit 14. The scoring unit 16 which follows provides the material web 9, along the envisaged folding line, with longitudinal scoring 17 which, in the case of the exemplary embodiment shown is offset laterally in relation to the center line of the material web 9. Downstream of the web-guiding roller 18, the material web 9 runs over the roof-like folding mechanism 19, which results in the material web 9 being folded along the scoring 17. The material web 9 is guided via the folding mechanism 19 under tensile stressing. This tensile stressing is produced by the pair of transporting rollers 13, arranged upstream of the folding mechanism 19, and the pair of transporting rollers 22, arranged downstream of the folding mechanism 19. By means of the perforating unit 20, the two material-web strands 9a, 9b of the folded material web 9, the strands being located one above the other, are provided with longitudinal perforations 21. The folded material web 9 passing out of the first, upper processing units 6 is guided via the compensating roller 23 and passes to the pair of drawing rollers 25, which, as has already been mentioned, belongs to the following processing unit.

FIG. 3 shows, the narrower material-web strand 9b is located beneath the wider material-web strand 9a. The fold here is located on the left-hand side, as seen in the advancement direction D of the material web 9. By virtue of the folding mechanism 19 being changed over, it is also possible for the material web 9 to be folded such that the fold is located on the right-hand side, as seen in the advancement direction D of the material web 9. By virtue of the scoring unit 16 and of the folding mechanism 19 being adjusted in a direction running at right angles to the advancement direction D of the material web 9, it is possible to change the position of the scoring 17 and of the folding line. The width of the material-web strands 9a and 9b can be adjusted in this way.

If the material web 9 is then to be processed, rather than in the first processing section 3 as described, in the lower, second processing section 5 (FIGS. 4-6), then the upper processing unit 6 is displaced into the non-operational position as is shown in FIGS. 7 and 8 and has already been described with reference to these figures. If the material web 9 is still located in the first, upper processing section 3, then it is necessary during this changeover, prior to the displacement of the upper processing unit 6, for the material web 9 to be severed in the region of the deflecting roller 12 and introduced into the second processing section 5.

In the case of the material web 9 being processed in the lower, second processing section 5, as shown in FIGS. 4-6, the material web 9 is likewise fed in a loop S to the entry 8 of the processing apparatus 1. Transportation of the material web through the processing section 5 under tensile stressing is also effected here by the pair of braking rollers 10 and the pair of drawing rollers 25. During passage through the longitudinal-cutting means 11, the border-cutting units 11b, 11c cut away the border portions 9′, 9″ and the web-cutting unit 11a separates the material web 9, along a line parallel to the advancement direction D, into two material-web strands 9d and 9e (FIG. 5). The one material-web strand 9d runs through the second processing section 5 along an essentially rectilinear movement path, whereas the material-web strand 9e located alongside it is guided via angle bars 26 such that the right-hand material-web strand 9e, as seen in the advancement direction D, ends up located beneath the left-hand material-web strand 9e, as seen in the advancement direction D, as seen in FIG. 6. It is also possible, however, for the material-web strand 9e to be guided via the angle bars 26 such that this material-web strand 9e ends up located above the other material-web strand 9d. This operation of the two material-web strands 9d, 9e, which are originally located one beside the other, being positioned one above the other is known per se. The material-web strands 9d, 9e located one above the other run past the web-guiding roller 27 and reach the pair of drawing rollers 25.

It is also possible to separate the material web 9 in the longitudinal-cutting means 11 into more than two material-web strands and then to position these material-web strands one above the other.

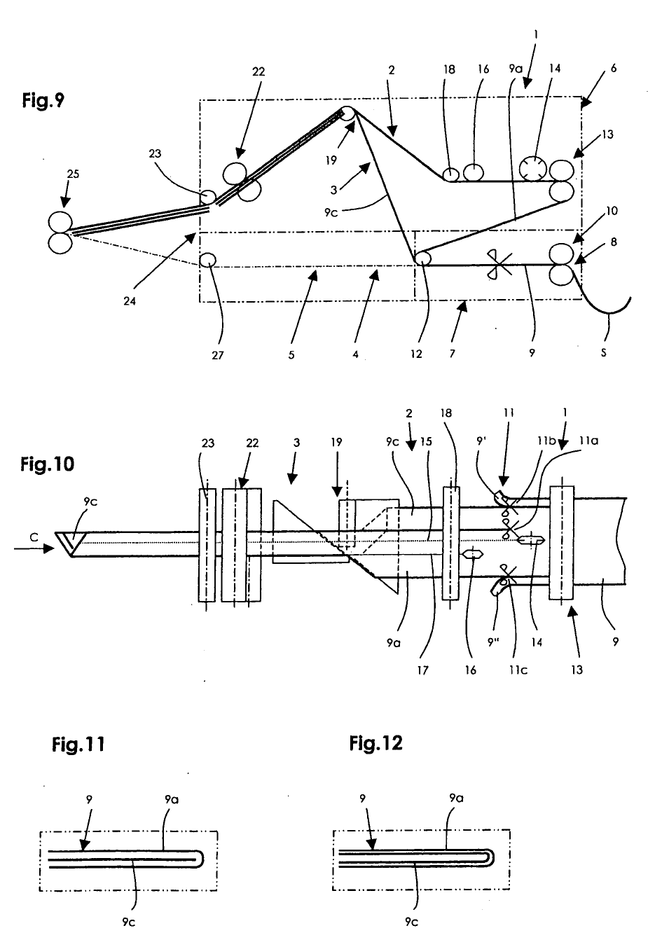

FIGS. 9-12 show another possible way of processing the material web 9 in the upper, first processing section 3. In the case of this embodiment, the material web 9, in the longitudinal-cutting means 11 is not only trimmed along the border, but separated into two material-web strands 9a and 9c by means of the web-cutting unit 11a. The material-web strand 9a runs through the processing section 3 in the same way as has been described with reference to FIGS. 1 and 2. That is to say, the material-web strand 9a is provided with longitudinal perforations 15 and with scoring 17. In contrast, the material-web strand 9c is guided from the deflecting roller 12 directly to the folding mechanism 19 and, upstream of this folding mechanism 19, is brought together with the other material-web strand 9a from beneath. As FIG. 11 shows, by virtue of the material-web strand 9a being folded, the material-web strand 9c is incorporated in the folded material-web strand 9a. As can be gathered from FIGS. 10 and 11, the material-web strand 9a in the non-folded state is approximately double the width of the other material-web strand 9c.

If, however, the material web 9 is divided up into two material-web strands 9a, 9c of approximately equal width and the material-web strand 9c is fed to the folding mechanism 19 in alignment with the material-web strand 9a, this gives rise to the end product which is illustrated in FIG. 12, and in which both material-web strands 9a and 9c are folded.

In the case of the embodiment which is shown in FIGS. 9 and 10, the perforating unit 20 has been done away with. It goes without saying, however, that it is also possible, if required, for such a perforating unit 20 to be provided for this embodiment. It is, of course, also possible for the material web 9 to undergo processing steps other than those described in the first processing section 3 or second processing section 5.

In the case of a further variant, a further folding unit may be provided in the processing apparatus 1 downstream of the folding mechanism 19 or downstream of the angle bars 26 as seen in the advancement direction D, in order for the material web 9 which has already been folded to be folded again and/or for the two material-web strands 9d, 9e located one above the other to be folded.

It has been described with reference to FIGS. 7 and 8 that the upper processing unit 6 is moved out of the movement path of the material web 9 by lateral displacement. It is also possible, however, for this first processing unit 6 to be moved into the non-operational position by displacement in the upward direction.

In the case of the exemplary embodiments shown, the processed material web 9 leaving the processing apparatus 1 is fed to a cross-cutting apparatus. Of course, it is also possible, instead of such a cross-cutting apparatus, to provide processing modules of other types.

What is claimed is:

1. A method of processing a printed material web moving in an advancement direction, the method comprising:
guiding the material web through at least one of a first processing section, where the material web is longitudinally folded about a line parallel to the advancement direction and a second processing section, where the material web is separated, by longitudinal cutting along at least one line parallel to the advancement direction, the material web being cut into at least two material-web strands, which are then positioned one above the other, wherein
the first processing section and second processing section are arranged as an upper processing section and a lower processing section, one of the first processing section and the second processing section above the other.

2. The method of claim 1, wherein the upper processing section, when not in use, is moved out of the movement path of the material web.

3. The method of claim 1, wherein, during processing of the material web in the upper processing section, the material web is deflected upward via at least one deflecting roller on an incoming side of the upper processing section.

4. The method of claim 1, wherein lateral border regions of the incoming material web are cut away in at least one of prior to the folding in the first processing section and together with the longitudinal cutting of the material web in the second processing section.

5. The method of claim 1, wherein the material web is braked at the entry to the first processing section and the second processing section and the material web is driven at the exit of the first processing section and the second processing section.

6. The method of claim 1, wherein, in the first processing section, the material web is guided, with tensile stressing, via a folding mechanism of roof-like design.

7. The method of claim 1, wherein, prior to the longitudinal folding in the first processing section, the material web is at least one of scored and perforated along the folding line.

8. The method of claim 1, wherein, at least one of prior to and following the longitudinal folding in the first processing section, the material web is provided with longitudinal perforations.

9. The method of claim 1, wherein, prior to the longitudinal folding of the material web in the first processing section, a material-web strand is severed from the material web along a line parallel to the advancement direction, and the severed material-web strand is positioned on a remaining material-web strand prior to the longitudinal folding of the material web strand.

10. The method of claim 1, wherein, in the second processing section, for positioning the material-web strands above one another, the material-web strand is guided via angle bars.

11. An apparatus for processing a printed material web moving in an advancement direction, the apparatus comprising:
a first processing arrangement and a second processing arrangement arranged one above the other having a common entry for the material web which is to be processed, wherein the material web is fed from the entry to at least one of the first processing arrangement and the second processing arrangement, the first processing arrangement is arranged to fold the material web about a line parallel to the advancement direction of the material web and the second processing arrangement is arranged to separate the material web into at least two material-web strands by longitudinal cutting along at least one line parallel to the advancement direction, and then to position the material-web strands one above the other.

12. The apparatus of claim 11, wherein an upper processing arrangement of the first processing arrangement and the second processing arrangement can be displaced to the side, as seen in respect to the advancement direction, relative to a lower processing arrangement.

13. The apparatus of claim 11, wherein the first processing arrangement includes a folding mechanism of roof-like design and via which the material web is guided under tensile stressing.

14. The apparatus of claim 11, wherein the second processing arrangement has a longitudinal-cutting unit for the longitudinal cutting of the material web and also has angle bars which are arranged downstream of the longitudinal-cutting unit and via which a material-web strand is guided.

15. The apparatus of claim 13, wherein the first processing arrangement has a scoring unit, which is arranged upstream of the folding mechanism for scoring the material web along a predetermined folding line, and a perforating unit, which is arranged upstream of the folding mechanism for perforating the material web along the envisaged folding line and for applying longitudinal perforations at a distance apart from the predetermined folding line.

16. The method of claim 6, wherein the tensile stressing is produced by transporting rollers arranged upstream and downstream of the folding mechanism.

17. The apparatus of claim 13, wherein transporting rollers are arranged upstream and downstream of the folding mechanism to produce the tensile stressing.
